(19) United States
(12) Patent Application Publication
(10) Pub. No.: US 2012/0062477 A1
(43) Pub. Date: Mar. 15, 2012

(54) Virtual touch control apparatus and method thereof

(75) Inventor: Chun-Huang Lin, HsinChu City (TW)

(73) Assignee: Chip Goal Electronics Corporation

(21) Appl. No.: 12/930,868

(22) Filed: Jan. 19, 2011

(30) Foreign Application Priority Data
Sep. 10, 2010 (TW) 099130662

(51) Int. Cl. G06F 3/041

(52) U.S. Cl. 345/173

(57) ABSTRACT

The present invention discloses a virtual touch control apparatus and a method thereof. The virtual touch control apparatus includes a virtual touch interface for generating a graphic display; a remote controller device controllable by a user to interact with the virtual touch control interface, wherein the interaction between the remote controller device and the virtual touch control interface generates a coordinate or an action command; a data format converter device converting the coordinate or action command into data with a format compatible to a physical touch control apparatus; and a processor for processing the converted data.

### BACKGROUND OF THE INVENTION

1. Field of Invention

The present invention relates to a virtual touch control apparatus and a method thereof, which enables a user to “touch” control the apparatus in a virtual and remote manner; furthermore, in the virtual touch control apparatus, the hardware circuitry (including the processor and circuits following the processor) and associated software are fully compatible with a current touch control apparatus.

2. Description of Related Art

Touch control apparatuses have become widely used in many applications, such as touchpad in a notebook computer, touch screen in an automatic teller machine, touch panel in a PDA or an electronic dictionary, etc. As shown in FIG. 1, a touch control apparatus typically includes a touch interface 10 which receives an external touch input, and a processor 20 which calculates a coordinate of the input. If different coordinates are obtained at different timings, the apparatus can generate displacement and speed information. Presently there are resistance-type and capacitance-type touch control apparatuses. A resistance-type touch control apparatus senses the touched position by voltage drop; when its screen is touched, a circuit is conducted which results in a voltage drop in the horizontal axis and a voltage drop in the vertical axis. The amounts of the voltage drops are different depending on the touched position, and therefore the x-y coordinates of the touched position may be obtained. A capacitance-type touch control apparatus includes an ITO (Indium Tin Oxide) glass substrate. A uniform electric field is formed over its surface by discharging from its corners. When a conductive object, such as a human finger, conducts current away from the electric field, the lost amount of current may be used to calculate the x-y coordinates of the touched position.

The applications of the aforementioned touch control apparatuses are limited; if a user can not directly contact the touch screen for certain reason, or if such touch screen is not available, the touch control functions can not operate. For example, a television screen can not be made a touch screen because of its large size and the associated cost, and usually a user would not sit very close to the television screen to touch it. As another example, if the image of the screen is projected from a projector, there is no touch screen for a user to touch.

### SUMMARY OF THE INVENTION

An objective of the present invention is to provide a virtual touch control apparatus, whose applications are not limited as the prior art touch control apparatuses and it can be used in applications where the prior art touch control apparatuses can not function. When a user can not conveniently touch the touch screen for certain reason, he still can execute the touch control functions. Furthermore, in the virtual touch control apparatus, the hardware circuitry including the processor and circuits following the processor and associated software are fully compatible with a current touch control apparatus. In the following context of the specification, the present invention is referred to as “virtual touch control apparatus”, and the current touch control apparatus which requires physical touch is referred to as “physical touch control apparatus”.

Another objective of the present invention is provide a virtual touch control method.

To achieve the foregoing objectives, in one perspective of the present invention, it provides a virtual touch control apparatus comprising: a virtual touch interface for generating a graphic display; a remote control device controllable by a user to interact with the virtual touch interface, wherein the interaction between the remote control device and the virtual touch interface generates a coordinate or an action command; a data format converter converting the coordinate or action command to data with a format compatible with a format of a physical touch control apparatus; and a processor for processing the converted data.

In another perspective of the present invention, it provides a virtue touch control method comprising: providing a virtual touch interface for generating a graphic display; providing a remote control device; generates a coordinate or an action command by interaction between the remote control device and the virtual touch interface; converting the coordinate or action command to data with a format compatible with a format of a physical touch control apparatus; and processing the converted data.

In the virtual touch control apparatus and method, if the interaction between the remote control device and the virtual touch interface generates a relative coordinate, preferably, the relative coordinate is converted to an absolute coordinate. Further, it is preferable to convert the coordinate according to a ratio between an area of overall coordinate outputs of the remote control device and a size of the graphic display generated by the virtual touch interface.

In one embodiment, the remote control device includes a button, and pressing and releasing the button indicate touching and being away from the virtual touch interface. The time period when the button is pressed indicates virtual pressure on the virtual touch interface; the longer the time period is, the higher the virtual pressure is.

In another embodiment, when the remote control device is moved by an acceleration larger than a predetermined threshold, it indicates touching the virtual touch interface, and when the acceleration is not larger than the predetermined threshold, it indicates that the user is moving the remote control device but does not intend to touch the virtual touch interface. When the acceleration is larger than the predetermined threshold, the larger the acceleration is, the higher the virtual pressure on the virtual touch interface is.

In yet another embodiment, when the remote control device points to a location and stays for a time period longer than a predetermined threshold, it indicates touching the virtual touch interface; when the remote control device stays pointing at the location for a time period not longer than the predetermined threshold, it indicates not touching the virtual touch interface. When the time period that the remote control device stays pointing at the location is longer than the predetermined threshold, the time period is converted to virtual pressure on the virtual touch interface.

In still another embodiment, the remote control device and the virtual touch interface interact with each other by optical communication, wherein if one of the remote control device and the virtual touch interface detects an optical signal from the other, it indicates touching the virtual touch interface, and any coordinate change afterward indicates (1) pure movement without touching the virtual touch interface, or (2) movement while keeping touching the virtual touch interface.

The objectives, technical details, features, and effects of the present invention will be better understood with regard to the detailed description of the embodiments below, with reference to the drawings.

### BRIEF DESCRIPTION OF THE DRAWINGS

FIG. 1 is a schematic block diagram of a prior art physical touch control apparatus.

FIG. 2 shows an embodiment of the virtual touch control apparatus according to the present invention.

FIG. 3 shows another embodiment of the virtual touch control apparatus according to the present invention.

FIG. 4 shows that “touch control regions” and “non-touch-control region” can be provided on a graphic display.

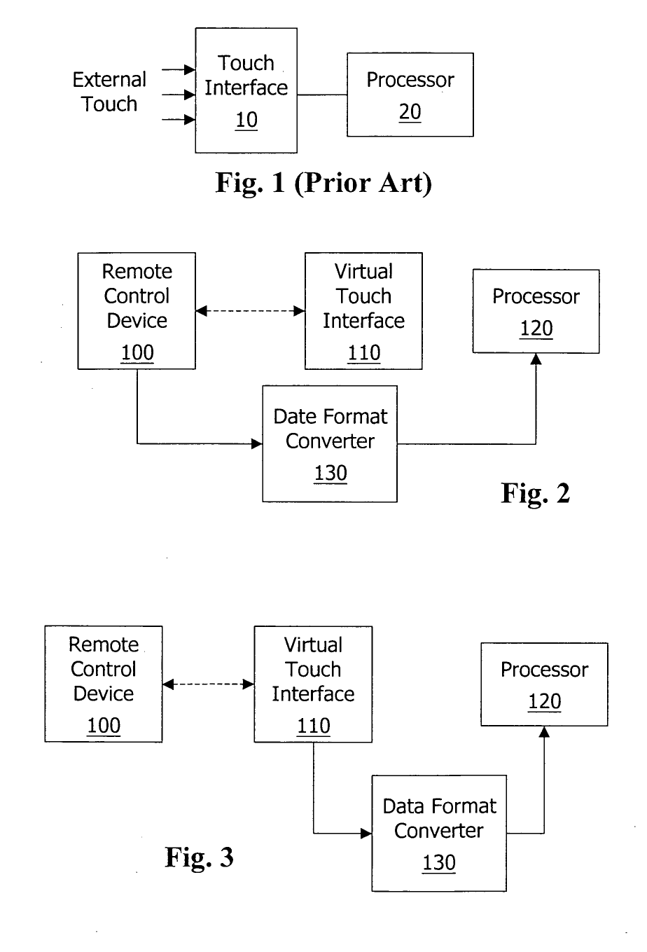

### DESCRIPTION OF THE PREFERRED EMBODIMENTS

The drawings as referred to throughout the description of the present invention are for illustration only, to show the interrelationships between the circuits or structural members, but not drawn according to actual scale.

The virtual touch control apparatus of the present invention can be (but not limited to being) applied to remote control without physical contact, but because one objective of the present invention is to improve the disadvantages of the current physical touch control apparatuses, the term “touch control” is still used in describing the present invention although there may not be physical contact.

Referring to FIGS. 2 and 3, the virtual touch control apparatus of the present invention basically includes a remote control device 100, a virtual touch interface 110, a processor 120 and a data format converter 130. The virtual touch interface 110 generates a graphic display; a user interacts with the virtual touch interface 110 by the remote control device 100, and the interaction generates a coordinate or meaningful action commands (e.g., indicating pressing a location on the graphic display). The user controls the remote control device 100 by, e.g., moving the remote control device 100 or pressing buttons on the remote control device 100. When the user moves the remote control device 100, preferably, an indicator is shown and correspondingly moves on the graphic display generated by the virtual touch interface 110. The coordinate or action command generated by the interaction can be converted to an electronic signal at the remote control device 100 (FIG. 2), or converted to an electronic signal at virtual touch interface 110 (FIG. 3). The data format converter 130 converts the electronic signal to data with a format that is compatible with the format of the current physical touch control apparatus, and sends the converted data to the processor 120 for data processing. Because the data received by the processor 120 is in proper format, the software in the processor 120 can adopt software currently used in a physical touch control apparatus, which is readily available. In other words, the processor 120 and any circuit following the processor 120 are compatible with the devices used in the current physical touch control apparatus.

The remote control device 100 and the virtual touch interface 110 can be embodied in various forms to meet the requirements of an application. For example, the remote control device 100 can be a remote controller of a television or a video player, a controller or a pointing device (such as a toy gun) of an electronic entertainment apparatus, an object capable of projecting light (such as but not limited to collimated light), and an object capable of receiving light. The virtual touch interface 110 can be any flat surface, for example can be a television screen or a projector plus a screen, or even a wall.

The remote control device 100 and the virtual touch interface 110 can be communicated with each other in wired or wireless manner; it suffices as long as the movement of the remote control device 100 is capable of generating different coordinates. For example, if the remote control device 100 is a controller of a video player and the virtual touch interface 110 is a projector plus a screen, a light source can be provided on the projector or the screen, and an image sensor can be provided in the remote control device 100, such that the remote control device 100 and the virtual touch interface 110 interact with each other by optical communication. When the remote control device 100 moves, the image sensor senses different images, and coordinates and displacements can be generated thereby. (Alternatively, the locations of the light source and the image sensor can be interchanged, i.e., the light source is provided on remote control device 100 and the image sensor is provided in the projector or the screen; or, both the light source and the image sensor can be provided at the same side, and a reflecting material is provided at the other side.) Or, a gyro-sensor or accelerometer can be provided in the remote control device 100, and an initial coordinate is given, so that the present coordinate or displacement can be calculated from the initial coordinate and the variations in the sensed gravity or acceleration. The above techniques are presently available and the details thereof are omitted here.

The data format converter 130 can be a stand-alone circuit, or it can be integrated in the remote control device 100, the virtual touch interface 110, or the processor 120. The data format converter 130 receives a coordinate or action command from the remote control device 100 (FIG. 2) or virtual touch interface 110 (FIG. 3), and converts it to data with a format compatible to the format of the current physical touch control apparatus; the converted data is sent to the processor 120. More specifically, the data format of the current physical touch control apparatus includes four items: (1) two-dimensional coordinate; (2) tip switch (touching or not); (3) in-range information; and (4) pressure. According to the present invention, the coordinate or action command received by the data format converter 130 can be converted in the following manners such that the data is compatible with the format of the current physical touch control apparatus:

I. Two-Dimensional Coordinate

The current physical touch control apparatus calculates coordinate and displacement according to absolute coordinate system (i.e., every location on a touch interface has an absolute coordinate). If the coordinate received by the data format converter 130 is a relative coordinate (the difference between the present location and a previous location), preferably, the data format converter 130 should convert the relative coordinate to an absolute coordinate. For example, this can be done by giving the remote control device 100 an initial coordinate in the initialization stage, such as by aiming the remote control device 100 to a designated location or other methods. In this way, any movement of the remote control device 100 afterward can be converted to an absolute coordinate. In addition, preferably, the data format converter 130 performs scaling conversion on the coordinate (i.e., mapping the coordinate to a larger or smaller scale) and then sends the converted data to the processor 120, wherein the conversion can be done according to the ratio between an area of overall coordinate outputs of the remote control device 100 and a size of the graphic display generated by the virtual touch interface 110, such that the coordinate processed by the processor 120 corresponds to the actual coordinate displayed by the virtual touch interface 110.

II. Tip Switch

According to the present invention, the action command “tip switch” can be achieved in various ways. For example, a button can be provided on the remote control device 100, and pressing and releasing the button indicate touching and being away from the virtual touch interface 110. Or, some actions by the remote control device 100 (such as fast circular moving in a small rang, or shaking the remote control device 100) can be defined as “one touch”. The action command indicating touching and the action command indicating moving can be distinguished from one the other by the acceleration of the remote control device 100. If the acceleration is larger than a predetermined threshold, it indicates touching the virtual touch interface 110, and if the acceleration is not larger than the predetermined threshold, it indicates that the user is moving the remote control device but does not intend to touch the virtual touch interface.

As another example, if the remote control device 100 is capable of projecting light (in this case the remote control device 100 includes a light source) and the virtual touch interface 110 includes an image sensor, then whether the light source projects light (or whether it projects an optical signal of a predefined spectrum or pattern) or not can be defined as “touching” or not: when the light source projects light and sensed by the image sensor, it indicates “touching”, and when the light source is OFF or when the image sensor can not sense the light from the light source, it indicates “not touching”. In this case, because the detection of light indicates “touching”, “touching” and “simply moving but not touching” should be distinguished from one the other. Several examples to distinguish “touching” from “simply moving” are described below:

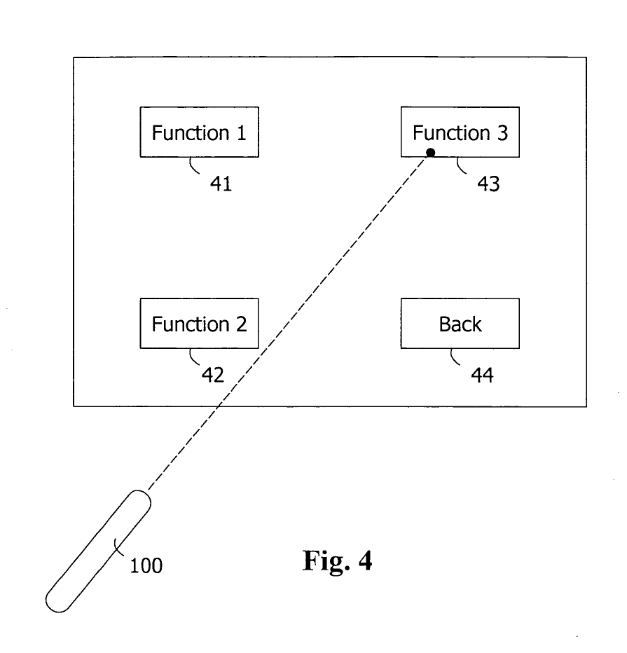

(1) “Touch control region(s)” and “non-touch-control region(s)” can be provided on the graphic display. Referring to FIG. 4, on the graphic display, the icons 41-44 are touch-controllable, while the area between the icons 41-44 is not touch-controllable. The movement of light in the area between the icons will not trigger the touch control function.

(2) When the image sensor first senses light, it indicates touching; any movement of the light afterward is not touching.

(3) When the light is projected to a location on the graphic display and stays for a time period longer than a predetermined threshold, it indicates touching; if it stays shorter time, it is not touching.

(4) When the image sensor first senses light, it indicates touching; any movement of the light afterward is both touching and moving.

One skilled in this art can readily conceive that in the above arrangements, the ON/OFF of the light source is equivalent to enabling/disabling the image sensor, and as stated above, the locations of the light source and the image sensor are interchangeable. The ON/OFF of the light source (or enablement/disablement of the image sensor) for example can be controlled by a button or by pressure. In the latter case, for example, if the remote control device 100 is a pen-shape object, it can be designed in such a way that the light source is turned ON when the user presses the pen-shape remote control device 100 on the graphic display.

III. In-Range

Certain physical touch control apparatuses support detection in the third dimension, to detect whether an object is close to the touch interface and trigger a touch control function accordingly. Certain other physical touch control apparatuses do not support this function, and it is only when there is physical contact that a touch control function is triggered. As to the present invention, because the present invention is already capable of remote touch control, such in-range function is already provided. If required, in the present invention, a button or other means can be provided to turn ON or OFF the detection in the third dimension, so that the remote touch control function is only performed in a predefined range.

IV. Pressure

According to the present invention, there are various ways to detect “pressure”, i.e., “virtual pressure” in the present invention. For example, if a button is provided on the remote control device 100, and pressing and releasing the button indicate touching and being away from the virtual touch interface 110, then it can be arranged in such a way that the time period when the button is pressed indicates the virtual pressure on the virtual touch interface; the longer the time period is, the higher the virtual pressure is. Or, if it is defined that when the remote control device is moved by an acceleration larger than a predetermined threshold, it indicates touching the virtual touch interface, then it can be arranged in such a way that, when the acceleration is larger than the predetermined threshold, the larger the acceleration is, the higher the virtual pressure on the virtual touch interface is. As another example, if the remote control device 100 is capable of projecting light, then the time period when the light stays at a certain location can be converted to the virtual pressure, and if it stays longer, the pressure is larger. More specifically, if the stay time is not longer than a predetermined threshold, it indicates not touching the virtual touch interface; if the stay time is longer than the predetermined threshold, it indicates touching, and the stay time is converted to the virtual pressure.

The above explains that the data format converter 130 converts the coordinate or action command it receives to data with a format compatible with the format of the current physical touch control apparatus. Therefore, to implement the present invention, the hardware circuitry including the processor 120 and circuits following the processor 120 and the associate software can adopt existing components of the current physical touch control apparatus. In addition to greatly reducing the development cost, this makes the present invention easier to be put to ready practice. The data format converter 130 can be implemented by hardware, software o firmware.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. In view of the foregoing, the spirit of the present invention should coverall such and other modifications and variations, which should be interpreted to fall within the scope of the following claims and their equivalents.

What is claimed is:

1. A virtual touch control apparatus, comprising:
a virtual touch interface for generating a graphic display;
a remote control device controllable by a user to interact with the virtual touch interface, wherein the interaction between the remote control device and the virtual touch interface generates a coordinate or an action command;
a data format converter converting the coordinate or action command to data with a format compatible with a format of a physical touch control apparatus; and
a processor for processing the converted data.

2. The virtual touch control apparatus as claimed in claim 1, wherein the interaction between the remote control device and the virtual touch interface generates a relative coordinate, and the data format converter converts the relative coordinate to an absolute coordinate.

3. The virtual touch control apparatus as claimed in claim 1, wherein the data format converter converts the coordinate according to a ratio between an area of overall coordinate outputs of the remote control device and a size of the graphic display generated by the virtual touch interface.

4. The virtual touch control apparatus as claimed in claim 1, wherein the remote control device includes a button, and pressing and releasing the button indicate touching and being away from the virtual touch interface.

5. The virtual touch control apparatus as claimed in claim 4, wherein the time period when the button is pressed indicates virtual pressure on the virtual touch interface; the longer the time period is, the higher the virtual pressure is.

6. The virtual touch control apparatus as claimed in claim 1, wherein when the remote control device is moved by an acceleration larger than a predetermined threshold, it indicates touching the virtual touch interface, and when the acceleration is not larger than the predetermined threshold, it indicates that the user is moving the remote control device but does not intend to touch the virtual touch interface.

7. The virtual touch control apparatus as claimed in claim 6, wherein when the acceleration is larger than the predetermined threshold, the larger the acceleration is, the higher the virtual pressure on the virtual touch interface is.

8. The virtual touch control apparatus as claimed in claim 1, wherein when the remote control device points to a location and stays for a time period longer than a predetermined threshold, it indicates touching the virtual touch interface; when the remote control device stays pointing at the location for a time period not longer than the predetermined threshold, it indicates not touching the virtual touch interface.

9. The virtual touch control apparatus as claimed in claim 8, wherein when the time period that the remote control device stays pointing at the location is longer than the predetermined threshold, the time period is converted to virtual pressure on the virtual touch interface.

10. The virtual touch control apparatus as claimed in claim 1, wherein the remote control device and the virtual touch interface interact with each other by optical communication, and wherein if one of the remote control device and the virtual touch interface detects an optical signal from the other, it indicates touching the virtual touch interface, and any coordinate change afterward indicates pure movement without touching the virtual touch interface.

11. The virtual touch control apparatus as claimed in claim 1, wherein the remote control device and the virtual touch interface interact with each other by optical communication, and wherein if one of the remote control device and the virtual touch interface detects an optical signal from the other, it indicates touching the virtual touch interface, and any coordinate change afterward indicates movement while keeping touching the virtual touch interface.

12. The virtual touch control apparatus as claimed in claim 1, wherein the remote control device is one of the followings: a remote controller of a television or a video player, a controller or pointing device of an electronic entertainment apparatus, an object capable of projecting light, and an object capable of receiving light.

13. A virtue touch control method, comprising:
providing a virtual touch interface for generating a graphic display;
providing a remote control device;
generates a coordinate or an action command by interaction between the remote control device and the virtual touch interface;
converting the coordinate or action command to data with a format compatible with a format of a physical touch control apparatus; and
processing the converted data.

14. The virtue touch control method as claimed in claim 13, wherein the interaction between the remote control device and the virtual touch interface generates a relative coordinate, and the method further comprises: converting the relative coordinate to an absolute coordinate.

15. The virtue touch control method as claimed in claim 13, further comprising: converting the coordinate according to a ratio between an area of overall coordinate outputs of the remote control device and a size of the graphic display generated by the virtual touch interface.

16. The virtue touch control method as claimed in claim 13, wherein the remote control device includes a button, and pressing and releasing the button indicate touching and being away from the virtual touch interface.

17. The virtue touch control method as claimed in claim 16, wherein the time period when the button is pressed indicates virtual pressure on the virtual touch interface; the longer the time period is, the higher the virtual pressure is.

18. The virtue touch control method as claimed in claim 13, wherein when the remote control device is moved by an acceleration larger than a predetermined threshold, it indicates touching the virtual touch interface, and when the acceleration is not larger than the predetermined threshold, it indicates that the user is moving the remote control device but does not intend to touch the virtual touch interface.

19. The virtue touch control method as claimed in claim 18, wherein when the acceleration is larger than the predetermined threshold, the larger the acceleration is, the higher the virtual pressure on the virtual touch interface is.

20. The virtue touch control method as claimed in claim 13, wherein when the remote control device points to a location and stays for a time period longer than a predetermined threshold, it indicates touching the virtual touch interface; when the remote control device stays pointing at the location for a time period not longer than the predetermined threshold, it indicates not touching the virtual touch interface.

21. The virtue touch control method as claimed in claim 20, wherein when the time period that the remote control device stays pointing at the location is longer than the predetermined threshold, the time period is converted to virtual pressure on the virtual touch interface.

22. The virtue touch control method as claimed in claim 13, wherein the remote control device and the virtual touch interface interact with each other by optical communication, and wherein if one of the remote control device and the virtual touch interface detects an optical signal from the other, it indicates touching the virtual touch interface, and any coordinate change afterward indicates pure movement without touching the virtual touch interface.

23. The virtue touch control method as claimed in claim 13, wherein the remote control device and the virtual touch interface interact with each other by optical communication, and wherein if one of the remote control device and the virtual touch interface detects an optical signal from the other, it indicates touching the virtual touch interface, and any coordinate change afterward indicates movement while keeping touching the virtual touch interface.
